(19) United States
(12) Patent Application Publication
(10) Pub. No.: US 2005/0071624 A1
(43) Pub. Date: Mar. 31, 2005

(54) Providing a self-describing media for a computer system

(76) Inventors: Michael A. Rothman, Olympia, WA (US); Vincent J. Zimmer, Federal Way, WA (US)

Correspondence Address: Anthony H. Azure;BLAKELY, SOKOLOFF, TAYLOR & ZAFMAN LLP, Seventh Floor, 12400 Wilshire Boulevard, Los Angeles, CA, 90025, US

(21) Appl. No.: 10/675,163

(22) Filed: Sep. 29, 2003

(51) Int. Cl. G06F 9/00; G06F 1/24

(52) U.S. Cl. 713/100

(57) ABSTRACT

A method and system to provide a self-describing media for a computer system. A media device is initialized during a pre-boot phase of the computer system. A description of content stored on a self-describing media coupled to the media device is read by firmware of the computer system during the pre-boot phase. A first portion of the content is extracted by the firmware, the first portion of the content to enable the firmware to recognize a second portion of the content. The second portion of the content of the self-describing media is accessed by the firmware. In one embodiment, the firmware of the computer system operates in accordance with the Extensible Firmware Interface (EFI) framework standard.

### BACKGROUND

1. Field of Invention

The field of invention relates generally to computer systems and, more specifically but not exclusively, relates to providing a self-describing media for a computer system.

2. Background Information

In a typical PC architecture, the initialization and configuration of the computer system by the Basic Input/Output System (BIOS) is commonly referred to as the pre-boot phase. The pre-boot phase is generally defined as the firmware that runs between the processor reset and the first instruction of the Operating System (OS) loader. At the start of a pre-boot, it is up to the code in the firmware to initialize the system to the point that an operating system loaded off of media, such as a hard disk, can take over. The start of the OS load begins the period commonly referred to as OS runtime. During OS runtime, the firmware acts as an interface between software and hardware components of a computer system. As computer systems have become more sophisticated, the operational environment between the application and OS levels and the hardware level is generally referred to as the firmware or the firmware environment.

Computer media, such as magnetic disks, magnet tapes, and optical disks, hold data that can be read and understood by a computer system. Different computer media often have a particular file system. In some cases, the computer media is formatted in a proprietary fashion promoted by a manufacturer of a media device drive. If the computer system does not have knowledge of the file system of the computer media, then the computer system cannot understand how the data is organized. Usually, a file system is mounted on the computer system that enables the computer system to interact with the computer media.

In the pre-boot environment, the multitude of file system formats available, both public and proprietary, can be troublesome for the firmware of the computer system. Due to the storage limitations of firmware, it is impractical for the firmware of a computer system to have inherent knowledge of numerous file system formats. Thus, firmware may not be able to understand a computer media because the firmware does not have the correct file system for reading the computer media during the pre-boot phase.

The inability of the firmware to read a computer media may hinder the ability to restore a computer system in a crisis recovery scenario. If the operating system boot media has failed, then the computer system may be recoverable from a back-up storage media, such as a magnetic tape. However, the back-up storage media may not be readable by the firmware because the firmware does not have knowledge of the file system encoding contained on the back-up storage media. Also, since the OS boot target is on the failed OS boot media, the OS is not available to load the proper file system for the back-up storage media. Thus, the back-up storage media cannot be utilized to recover the computer system.

### BRIEF DESCRIPTION OF THE DRAWINGS

The present invention is illustrated by way of example and not limitation in the accompanying figures.

FIG. 1 is a schematic diagram illustrating one embodiment of a self-describing media in accordance with the teachings of the present invention.

FIG. 2 is a schematic diagram illustrating one embodiment of a self-describing media in accordance with the teachings of the present invention.

FIG. 3A is a schematic diagram illustrating one embodiment of a self-describing media in accordance with the teachings of the present invention.

FIG. 3B is a schematic diagram illustrating one embodiment of a self-describing media in accordance with the teachings of the present invention.

FIG. 4 is a flowchart illustrating one embodiment of the logic and operations to provide a self-describing media for a computer system in accordance with the teachings of the present invention.

FIG. 5 is a flowchart illustrating one embodiment of the logic and operations to provide a self-describing media for a computer system in accordance with the teachings of the present invention.

FIG. 6 is a schematic diagram illustrating one embodiment of a computer system in accordance with the teachings of the present invention.

### DETAILED DESCRIPTION

Embodiments of a method and system to provide a self-describing media for a computer system are described herein. In the following description, numerous specific details are set forth, such as embodiments pertaining to the Extensible Firmware Interface (EFI) framework standard, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In one embodiment of the present invention, a self-describing media is provided to a computer system. The self-describing media may be read by firmware during a pre-boot phase of the computer system. In one embodiment, the self-describing media includes a file system driver to allow the firmware to mount a file system for discerning the data stored on the self-describing media. In another embodiment, the self-describing media includes a pre-boot recovery utility to enable recovery of a storage device from data stored on the self-describing media during the pre-boot phase of the computer system.

In one embodiment of the present invention, firmware of a computer system operates in accordance with an extensible firmware framework known as the Extensible Firmware Interface (EFI) (EFI Specification, Version 1.10, Dec. 1, 2002, may be found at http://developer.intel.com/technology/efi). EFI is a public industry specification that describes an abstract programmatic interface between platform firmware and shrink-wrap operating systems or other custom application environments. The EFI framework standard includes provisions for extending BIOS functionality beyond that provided by the BIOS code stored in a platform's BIOS device (e.g., flash memory). More particularly, EFI enables firmware, in the form of firmware modules and drivers, to be loaded from a variety of different resources, including primary and secondary flash devices, option ROMs (Read-Only Memory), various persistent storage devices (e.g., hard disks, CD-ROM (Compact Disk-Read Only Memory), etc.), and from one or more computer systems over a computer network.

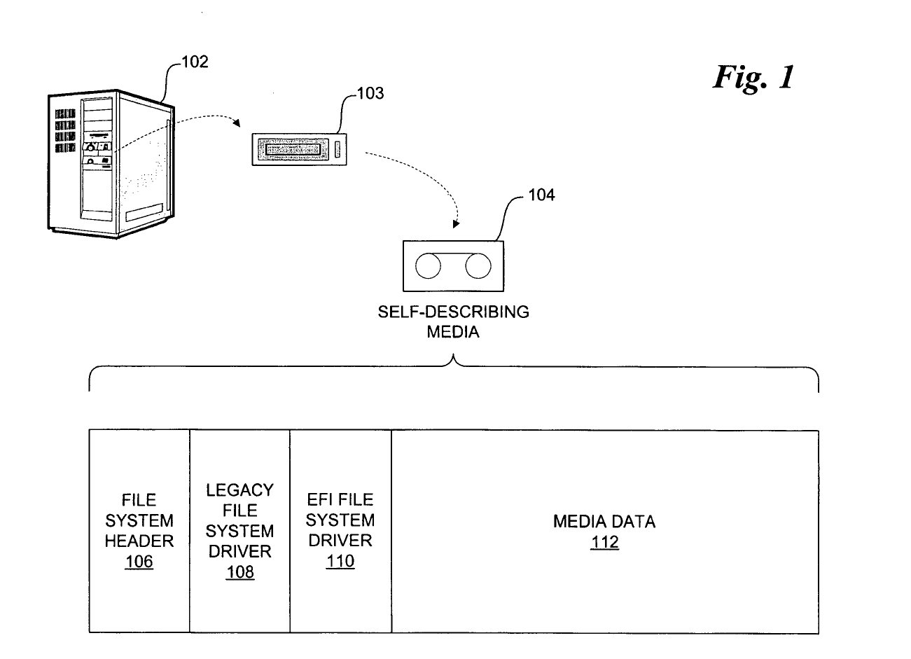

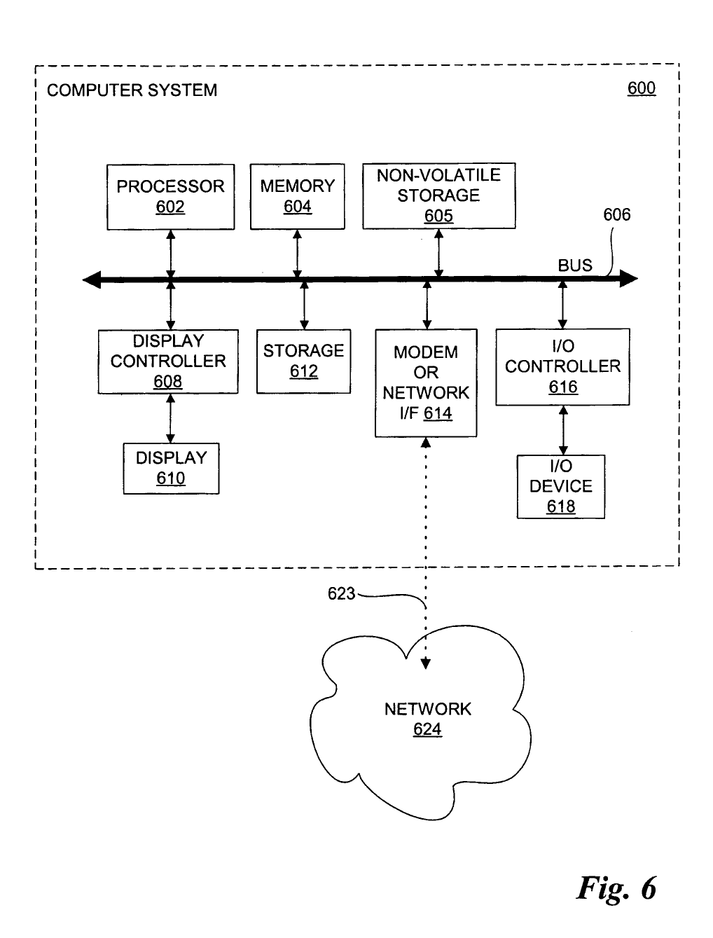

FIG. 1 illustrates one embodiment of the present invention to provide a self-describing media. FIG. 1 shows a computer system 102. In one embodiment, computer system 102 is similar to the example computer system described below in conjunction with FIG. 6. Computer system 102 includes a media device 103 for interacting with a self-describing media 104. Self-describing media 104 includes a computer readable media, such as, but not limited to, a magnetic tape, a magnetic disk, an optical disk, a non-volatile memory card, or the like. In the embodiment shown in FIG. 1, the self-describing 104 is a streaming media such as a magnetic tape. The computer system 102 also includes non-volatile storage (not shown) to store firmware executable by the computer system.

FIG. 1 also shows an organization of information on the self-describing media 104 in accordance with one embodiment of the present invention. Self-describing-media 104 includes a file system header 106, a legacy file system driver 108, and an EFI file system driver 110. It will be understood that the arrangement of information on the self-describing media 104 is not limited to the embodiments described herein. The file system header 106 describes content of the self-describing media 104. The file system header 106 is readable by the firmware of the computer system 102. By using the file system header 106, the firmware may access content stored on the self-describing media 104.

The following is one embodiment of the file system header 106:

| | | |
|---|---|---|
| UINT32 | LengthOfLegacyDriver; | /*UINT32 represents a 32-bit value |
| UINT32 | LengthOfEFIDriver; | |
| UINT32 | LegacyDriverOffSet; | |
| UINT32 | EFIDriverOffset; | |

A file system driver enables a computer system to access the media data stored on a computer readable media in a logical manner. The file system driver describes the file system format of the media data and enables the computer system to mount a file system for the self-describing media. The legacy file system driver 108 allows a legacy firmware environment to understand the media data 112. The EFI file system driver 110 allows firmware operating in accordance with the EFI framework standard to understand the media data 112. Media data 112 includes, but is not limited to, data and executable code.

The self-describing media 104 contains the information the firmware may need to enable the firmware to read and understand the media data 112 of the self-describing media 104. The firmware does not have to have prior knowledge of the file system of the media data 112, but the firmware need only be able to read the file system header 106. It will be understood that the firmware will have prior knowledge as to the format of the file system header 106. The file system header 106 will direct the firmware to the appropriate file system driver for the media data 112. The firmware can then launch the appropriate file system driver to enable the firmware to mount the file system for reading the media data 112.

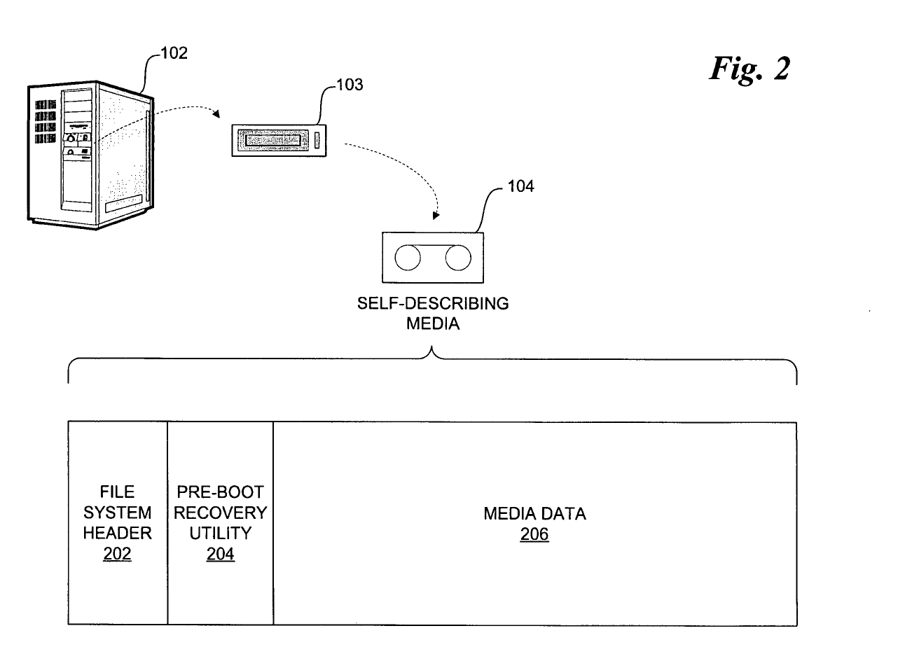

FIG. 2 illustrates one embodiment of the present invention to provide a self-describing media. FIG. 2 shows the self-describing media 104 for use with computer system 102 via media device 103. In one embodiment, the self-describing media 104 is a backup tape storage for computer system 102. The self-describing media 104 includes a file system header 202, a pre-boot recovery utility 204, and a media data 206. The file system header 202 describes information stored on the self-describing media and is readable by the firmware of the computer system. The pre-boot recovery utility 204 is a utility to enable the recovery of data during the pre-boot phase on a storage device of the computer system 102. In an embodiment of a backup tape, because the pre-boot recovery utility 204 is on the self-describing media itself, the computer system may be recovered without the necessity of any other media. Also, in an embodiment of a backup tape, it will be appreciated that the computer system is recoverable from the backup tape that may not normally be an OS boot target of the computer system. The firmware of the computer system 102 may execute the pre-boot recovery utility 204. In one embodiment, the pre-boot recovery utility 204 is an EFI application executable by the firmware of computer system 102.

For example, if a hard disk of computer system 102 has become corrupted, the firmware may use the pre-boot recovery utility 204 to restore the hard disk. The operating system boot target stored on the hard disk may not be executable, but self-describing media 104 may have a snapshot image of the hard disk located in the media data 206. The firmware may use the pre-boot recovery utility 204 during the pre-boot phase to recover the hard disk from the media data 206. Thus, because the self-describing media 104 contains the information the firmware needs to understand the self-describing media 104, the firmware does need other resources to read the self-describing media 104 that may be inaccessible because these resources are stored on the corrupted hard disk. The firmware may interact with the self-describing media 104 in an OS agnostic manner; the firmware may read and write to the self-describing media during pre-boot without knowledge of the OS boot target.

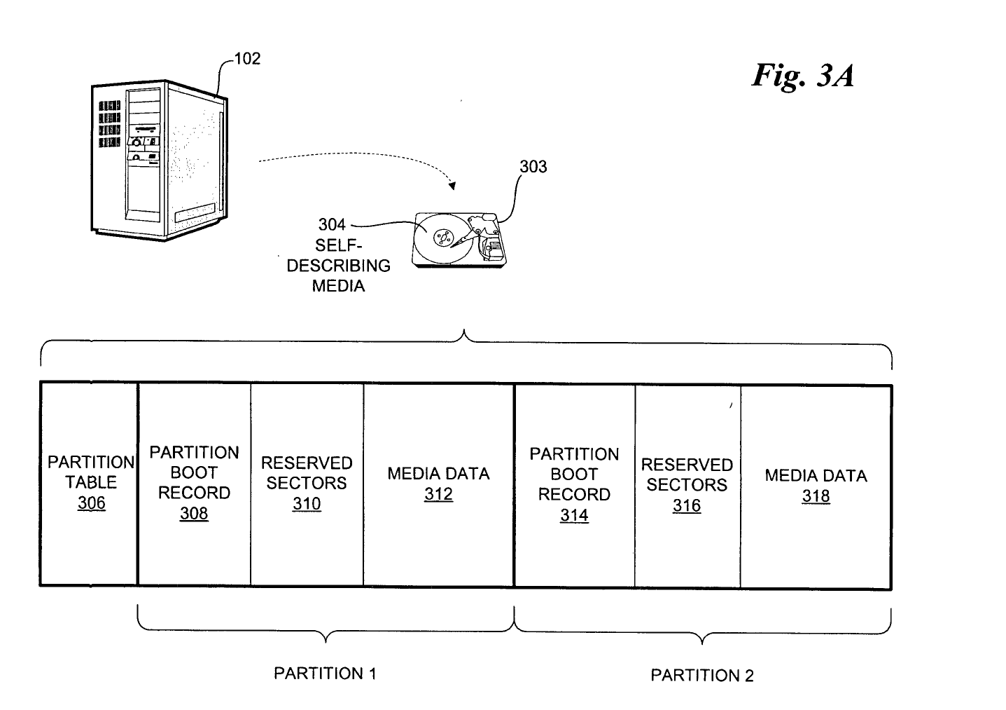

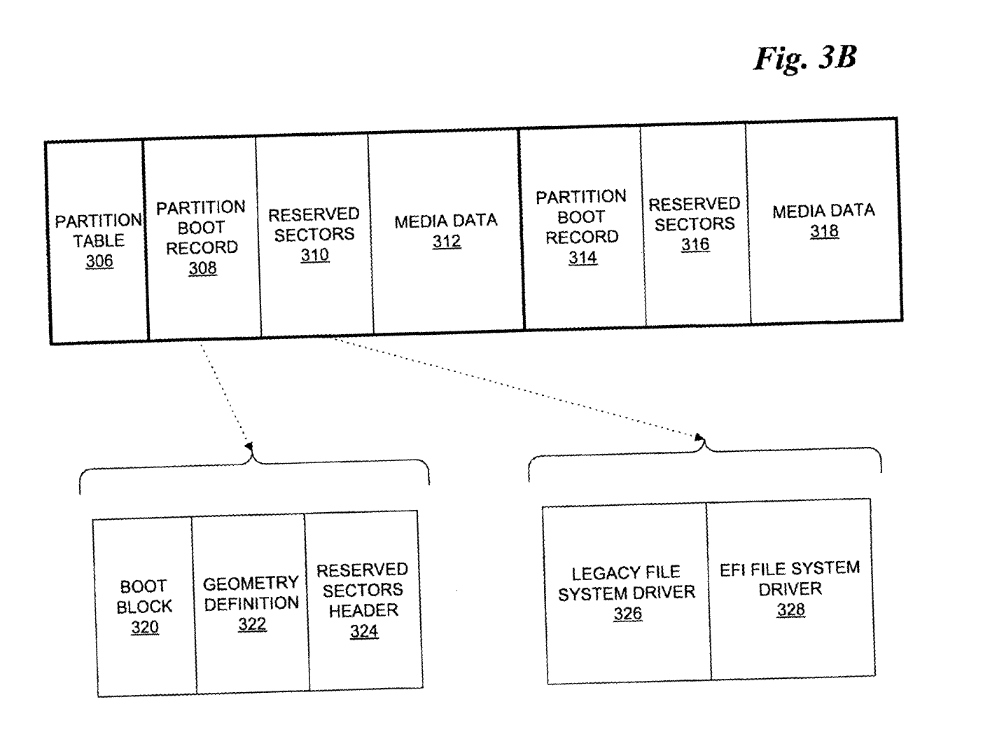

FIGS. 3A and 3B illustrate one embodiment of the present invention to provide a self-describing media. In FIG. 3A, computer system 102 has a media device 303 for reading a self-describing media 304. Self-describing media 304 is a rotating computer readable media that includes, but is not limited to, a magnetic disk, an optical disk, or the like. FIGS. 3A and 3B show one embodiment of a partition file system. Embodiments of the present invention are not limited to the partitioning scheme as shown in FIGS. 3A and 3B.

The self-describing media 304 includes a partition table 306. The partition table 306 indicates the location of one or more partitions of the self-describing media 304. The self-describing media 304 includes partition 1 and partition 2. Partition 1 includes partition boot record 308, reserved sectors 310, and media data 312. Partition 2 includes partition boot record 314, reserved sectors 316, and media data 318. The partition table 306 points to partition boot record 308 and partition boot record 314. Partition boot records 308 and 314 include information regarding the organization of the data within their respective partitions. Reserved sectors 310 include space reserved for special use by the computer system 102. Media data 312 and 318 include data and executable code, usually arranged in files, that is stored on the self-describing media 304.

FIG. 3B shows one embodiment of partition boot record 308 and reserved sectors 310. The partition boot record 308 includes boot block 320, geometry definition 322, and reserved sectors header 324. In one embodiment, the boot block contains executable code to begin the loading of the operating system stored in that partition. The geometry definition 322 includes information regarding the physical arrangement of partition 1. In one embodiment, the geometry definition 322 may describe the tracks, cylinders, and sectors of partition 1. The reserved sectors header 324 describes the location of one or more reserved sectors in partition 1.

The reserved sectors 310 include special information for use by the computer system 102. In the embodiment shown in FIG. 3B, the reserved sectors 310 include a legacy file system driver 326 and an EFI file system driver 328.

In another embodiment, the reserved sectors 310 include a pre-boot recovery utility. Thus, a rotating media may be able to recover itself if portions of the rotating media have been corrupted. For example, the self-describing media 304 may contain the OS boot target for the computer system. If critical OS boot target information has been corrupted, such as registry files, the OS may not be able to boot. However, the firmware can locate and launch a pre-boot recovery utility stored in one or more reserved sectors of the self-describing media 304. This pre-boot recovery utility may have knowledge of content on the rotating media to enable recovery of the OS boot target.

The embodiment shown in FIGS. 3A and 3B allows the firmware to discover information regarding the self-describing media 304 during the pre-boot phase of the computer system 102. In one embodiment, the legacy file system driver 326 and EFI file system driver 328 allow the firmware to mount a file system during pre-boot for reading the media data 312 of partition 1. In another embodiment, the firmware may find and execute a pre-boot recovery utility stored in the reserved sectors 310.

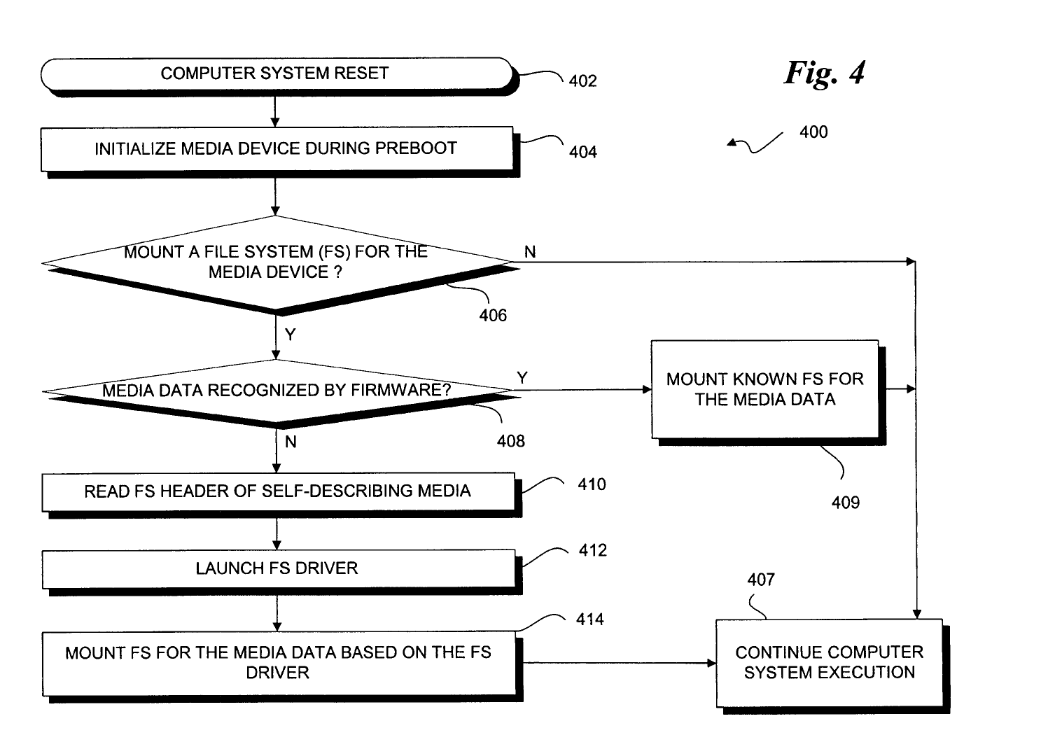

Referring to FIG. 4, a flowchart 400 shows one embodiment of a method to provide a self-describing media for a computer system. In a block 402, a computer system is reset. Pre-boot initialization of the computer system will begin based on firmware available to the computer system. In one embodiment, the system boot instructions will begin initializing the computer system by conducting a Power-On Self-Test (POST) routine, initializing system board functions, checking for any expansion boards that hold additional BIOS code, and loading such BIOS code if any is found.

Continuing to a block 404, a media device of the computer system is initialized by the firmware during the pre-boot phase of the computer system. This initialization provides the firmware with an interface to access self-describing media that may be placed in the media device. In one embodiment, the firmware may access the media device through the functions of the interrupt INT 13h. In another embodiment, a Block Input/Output (I/O) interface, such as, but not limited to, LBA (Logical Block Addressing), is layered onto I/O access to the media device. In one embodiment, the Block I/O interface operates in conjunction with EFI firmware.

In a decision block 406, the logic determines if a file system is to be mounted for the media device. If the answer is no, then the logic proceeds to a block 407 to continue execution of the computer system. If the answer is yes, then the logic proceeds to a decision block 408.

In decision block 408, the logic determines if the media data stored on a self-describing media in the media device is recognized by the firmware of the computer system. If the answer is yes, then the logic proceeds to a block 409 to mount a known file system for the media device. Mounting a file system involves making a file system available for access by the computer system. Mounting a file system exposes an interface to the computer system for interacting with the media data of the self-describing media. In one embodiment, the known file system is stored in the firmware of the computer system. The logic then proceeds to block 407 to continue execution of the computer system.

If the answer to decision block 408 is no, then the logic proceeds to a block 410 to read the file system header of the self-describing media. The file system header describes content of the self-describing media and leads the firmware to the location of a file system driver stored on the self-describing media. Based on the file system header, the firmware may access content of the self-describing media. In a block 412, the file system driver is launched by the firmware.

In one embodiment, an EFI file system driver layers on top of the Block I/O interface and produces a file-system abstraction to access logically organized data on the self-describing media. For example, even though a floppy disk may be addressable via an INT 13h interrupt or a Block I/O interface, the ability to access logical content, such as “files”, requires a higher-level abstraction that understands the organization of the data stored on the media. The file system serves to facilitate this higher-level abstraction. The file system driver allows a file system to be mounted. The file system knows how to interpret the data contained on the self-described media so the computer system can access the data in a logical higher-level manner. A user sees these higher-level abstractions as “files.”

Continuing to a block 414, the firmware mounts the file system based on the file system driver. By extracting the file system driver and mounting the corresponding file system, the firmware gains logical access to the media data stored on the self-describing media. The logic proceeds to block 407 to continue execution of the computer system.

It will be apparent that the self-describing media includes a file system driver for understanding the media data. This allows the firmware to extract the file system driver and to mount the appropriate file system. Thus, a user of the computer system may view the files of the self-describing media during the pre-boot phase. For example, the firmware may recognize media formatted for the FAT (File Allocation Table) file system. However, the self-describing media may include a file system driver for the NFS (Network File System) to enable the firmware to read media data formatted for NFS.

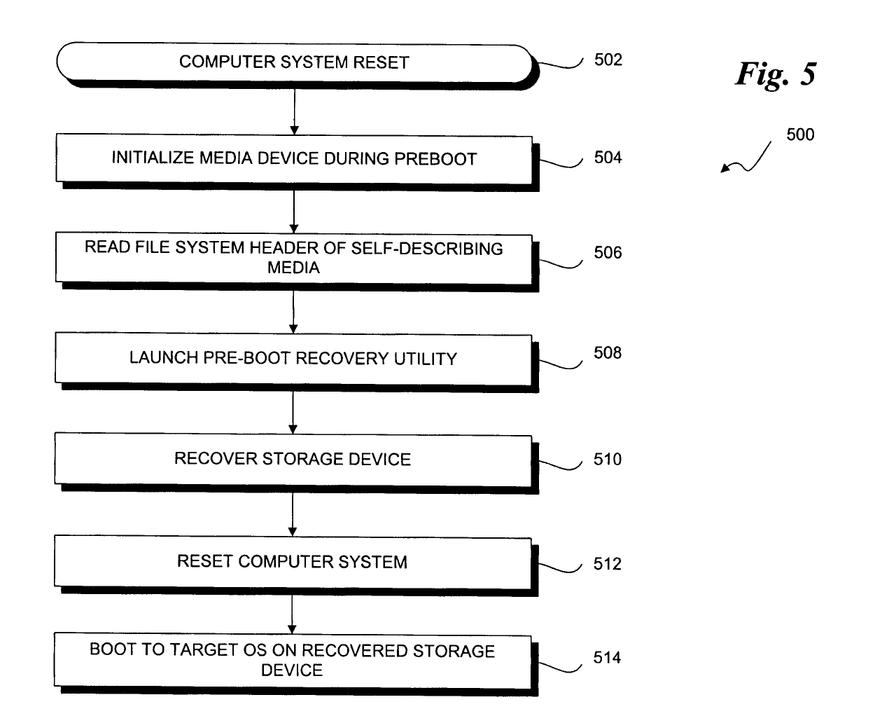

Referring to FIG. 5, a flowchart 500 shows one embodiment of a method to provide a self-describing media for a computer system. In a block 502, a computer reset is performed. In a block 504, a media device of the computer system is initialized during the pre-boot phase. In a block 506, a file system header of the self-describing media accessible by the media device is read by firmware of the computer system. The firmware is aware of the format of the file system header. The file system header indicates the location of a pre-boot recovery utility stored on the self-describing media.

In one embodiment, the self-describing media of FIG. 5 is a back-up storage tape. The pre-boot recovery utility enables the firmware to execute the pre-boot utility to recover a storage device of the computer system from media data stored on the self-describing media.

In a block 508, the pre-boot recovery utility is launched by the firmware of the computer system. The pre-boot recovery utility enables the firmware to recognize the media data for recovering a storage device of the computer system. In one embodiment, the pre-boot recovery utility is to operate with legacy firmware of the computer system, while in another embodiment, the pre-boot recovery utility is to operate with an EFI firmware environment. In one embodiment, when the self-described media is formatted at the computer system, the pre-boot recovery utility is placed on the self-describing media by the formatting application. In a crisis recovery scenario, when the pre-boot recovery utility is launched, it provides a user interface to enable a user to utilize the content of the self-describing media during pre-boot. The content may be accessed and recovery performed without the need to launch a viable operating system or run an OS present application to perform the recovery.

In a block 510, a storage device of the computer system is recovered from the self-describing media. The pre-boot recovery utility executes in the firmware environment to enable the firmware to restore at least a portion the storage device from media data of the self-describing media. In one embodiment, a user may select files from the storage device to be recovered from the self-describing media. In another embodiment, the self-describing media is a back-up tape that stores a snapshot image of a hard drive of the computer system. In this embodiment, the pre-boot recovery utility may re-write the entire hard drive with the snapshot image.

Continuing to a block 512, the computer system is reset. In a block 514, the computer system is booted to a target operating system stored on the storage device recovered by the pre-boot recovery utility.

FIG. 6 is an illustration of one embodiment of an example computer system 600 on which embodiments of the present invention may be implemented. Computer system 600 includes a processor 602 coupled to a bus 606. Memory 604, storage 612, non-volatile storage 605, display controller 608, input/output controller 616 and modem or network interface 614 are also coupled to bus 606. The computer system 600 interfaces to external systems through the modem or network interface 614. This interface 614 may be an analog modem, Integrated Services Digital Network (ISDN) modem, cable modem, Digital Subscriber Line (DSL) modem, a T-1 line interface, a T-3 line interface, token ring interface, satellite transmission interface, or other interfaces for coupling a computer system to other computer systems. A carrier wave signal 623 is received/transmitted by modem or network interface 614 to communicate with computer system 600. In the embodiment illustrated in FIG. 6, carrier waive signal 623 is used to interface computer system 600 with a computer network 624, such as a local area network (LAN), wide area network (WAN), or the Internet. In one embodiment, computer network 624 is further coupled to a remote computer (not shown), such that computer system 600 and the remote computer can communicate.

Processor 602 may be a conventional microprocessor including, but not limited to, an Intel Corporation x86, Pentium, or Itanium family microprocessor, a Motorola family microprocessor, or the like. Memory 604 may include, but not limited to, Dynamic Random Access Memory (DRAM), Static Random Access Memory (SRAM), Synchronized Dynamic Random Access Memory (SDRAM), Rambus Dynamic Random Access Memory (RDRAM), or the like. Display controller 608 controls in a conventional manner a display 610, which in one embodiment may be a cathode ray tube (CRT), a liquid crystal display (LCD), an active matrix display, or the like. An input/output device 618 coupled to input/output controller 616 may be a keyboard, disk drive, printer, scanner and other input and output devices, including a mouse, trackball, trackpad, joystick, or other pointing device.

The computer system 600 also includes non-volatile storage 605 on which firmware and/or data may be stored. Non-volatile storage devices include, but are not limited to, Read-Only Memory (ROM), Flash memory, Erasable Programmable Read Only Memory (EPROM), Electronically Erasable Programmable Read Only Memory (EEPROM), or the like.

Storage 612 in one embodiment may be a magnetic hard disk, an optical disk, or another form of storage for large amounts of data. Some data may be written by a direct memory access process into memory 604 during execution of software in computer system 600. It is appreciated that software may reside in storage 612, memory 604, non-volatile storage 605 or may be transmitted or received via modem or network interface 614.

For the purposes of the specification, a machine-readable medium includes any mechanism that provides (i.e., stores and/or transmits) information in a form readable or accessible by a machine (e.g., a computer, network device, personal digital assistant, manufacturing tool, any device with a set of one or more processors, etc.). For example, a machine-readable medium includes, but is not limited to, recordable/non-recordable media (e.g., a read only memory (ROM), a random access memory (RAM), a magnetic disk storage media, an optical storage media, a flash memory device, etc.). In addition, a machine-readable medium can include propagated signals such as electrical, optical, acoustical or other form of propagated signals (e.g., carrier waves, infrared signals, digital signals, etc.).

It will be appreciated that computer system 600 is one example of many possible computer systems that have different architectures. For example, computer systems that utilize the Microsoft Windows® operating system in combination with Intel microprocessors often have multiple buses, one of which may be considered a peripheral bus. Workstation computers may also be considered as computer systems that may be used with the present invention. Workstation computers may not include a hard disk or other mass storage, and the executable programs are loaded from a corded or wireless network connection into memory 604 for execution by processor 602. In addition, handheld or palmtop computers, which are sometimes referred to as personal digital assistants (PDAs), may also be considered as computer systems that may be used with the present invention. As with workstation computers, handheld computers may not include a hard disk or other mass storage, and the executable programs are loaded from a corded or wireless network connection into memory 604 for execution by processor 602. A typical computer system will usually include at least a processor 602, memory 604, and a bus 606 coupling memory 604 to processor 602.

It will also be appreciated that in one embodiment, computer system 600 is controlled by operating system software. For example, one embodiment of the present invention utilizes Microsoft Windows® as the operating system for computer system 600. In other embodiments, other operating systems that may also be used with computer system 600 include, but are not limited to, the Apple Macintosh operating system, the Linux operating system, the Microsoft Windows CE® operating system, the Unix operating system, the 3Com Palm operating system, or the like.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

1. A method, comprising:
initializing a media device during a pre-boot phase of a computer system;
reading a description of content stored on a self-describing media by firmware of the computer system during the pre-boot phase, the self-describing media coupled to the media device;
extracting a first portion of the content by the firmware to enable the firmware to recognize a second portion of the content; and
accessing the second portion of the content by the firmware.

2. The method of claim 1 wherein extracting the first portion of the content comprises launching a pre-boot recovery utility extracted from the first portion of content to recover a storage device of the computer system.

3. The method of claim 2 wherein the pre-boot recovery utility is an Extensible Firmware Interface (EFI) application.

4. The method of claim 2 wherein accessing the second portion of the content comprises writing a portion of the second portion of the content to the storage device using the pre-boot recovery utility.

5. The method of claim 2 wherein the storage device includes a magnetic hard disk.

6. The method of claim 2 wherein the media device includes a magnetic tape drive and the self-describing media includes a magnetic tape.

7. The method of claim 6, further comprising recovering an operating system boot target stored on a storage device of the computer system from the magnetic tape using the pre-boot recovery utility during the pre-boot phase.

8. The method of claim 1 wherein extracting the first portion of the content comprises:
launching a file system driver stored in the first portion of the content; and
mounting a file system on the computer system based on the file system driver.

9. The method of claim 8 wherein the file system driver to operate in accordance with the EFI framework standard.

10. The method of claim 8 wherein accessing the second portion of the content comprises accessing the second portion of the content by the firmware via the file system during the pre-boot phase.

11. The method of claim 8, further comprising mounting a known file system on the computer system if the firmware recognizes the second portion of the content.

12. The method of claim 11 wherein the known file system is stored in the firmware.

13. An article of manufacture comprising:
a machine-readable medium including a plurality of instructions which when executed perform operations comprising:
initializing a media device during a pre-boot phase of a computer system;
reading a file system header stored on a self-describing media accessed by the media device during the pre-boot phase, the file system header describing information to enable the computer system to recognize media data stored on the self-describing media;
extracting the information from the self-describing media to recognize the media data; and
accessing the media data stored on the self-describing media.

14. The article of manufacture of claim 13 wherein initializing the media device comprises layering an Input/Output interface onto an Input/Output access to the media device.

15. The article of manufacture of claim 13 wherein extracting the information from the self-describing media comprises launching a pre-boot recovery utility described by the file system header to recover a storage device of the computer system from the media data during the pre-boot phase.

16. The article of manufacture of claim 15 wherein the pre-boot recovery utility is an EFI application.

17. The article of manufacture of claim 15 wherein accessing the media data comprises writing a portion of the media data from the self-describing media to the storage device using the pre-boot recovery utility.

18. The article of manufacture of claim 13 wherein extracting the information from the self-describing media comprises:
launching a file system driver stored on the self-describing media during the pre-boot phase, the file system driver described by the file system header; and
mounting a file system on the computer system based on the file system driver during the pre-boot phase, the file system to enable the computer system to read the media data stored on the self-describing media.

19. The article of manufacture of claim 18 wherein the file system driver to operate in accordance with the EFI framework standard.

20. The article of manufacture of claim 18 wherein execution of the plurality of instructions further perform operations comprising mounting a known file system on the computer system if the computer system recognizes the media data.

21. A computer system, comprising:
a processor; and
at least one flash device operatively coupled to the processor, the at least one flash device including firmware instructions which when executed by the processor perform operations comprising:
initializing a media device during a pre-boot phase of a computer system;
reading a file system header stored on a self-describing media coupled to the media device during the pre-boot phase, the file system header indicating the location of information to enable the firmware to recognize media data stored on the self-describing media;
extracting the information from the self-describing media to recognize the media data; and
accessing the media data stored on the self-describing media using the extracted information.

22. The computer system of claim 21 wherein extracting the information from the self-describing media comprises launching a pre-boot recovery utility located via the file system header to recover a storage device of the computer system from the media data during the pre-boot phase.

23. The computer system of claim 22 wherein execution of the plurality of instructions further perform operations comprising recovering a corrupted operating system boot target stored on the storage device using the pre-boot recovery utility, wherein the self-describing media includes a magnetic backup tape.

24. The computer system of claim 21 wherein extracting the information from the self-describing media comprises:
launching a file system driver stored on the self-describing media, wherein the file system driver located via by the file system header; and
mounting a file system on the computer system based on the file system driver, the file system to enable firmware of the computer system to read the media data.

25. The computer system of claim 21 wherein the firmware to operate in accordance with an Extensible Firmware Interface (EFI) framework standard.
